(19) United States
(12) Patent Application Publication
(10) Pub. No.: US 2016/0306869 A1
(43) Pub. Date: Oct. 20, 2016

(54) Business Intelligence Computing System Supporting Hierachies for Relational Data

(71) Applicant: Tobias Weller, Buseck (DE)

(72) Inventor: Tobias Weller, Buseck (DE)

(21) Appl. No.: 14/690,728

(22) Filed: Apr. 20, 2015

(51) Int. Cl. G06F 17/30; G06Q 10/10

(52) U.S. Cl. CPC G06F 17/30589; G06F 17/30342; G06F 17/30604; G06F 17/30513; G06Q 10/10

(57) ABSTRACT

A business intelligence (BI) computing system obtains a plurality of relational data records from a data source that has an associated hierarchy description. The BI computing system, using the hierarchy description, next builds a hierarchical structure of the plurality of data records. Subsequently, the BI computing system, using the hierarchical structure, initiates at least one hierarchical workflow operation to allow a user to display, analyze, and navigate the plurality of data records on a BI client. Related apparatus, systems, techniques and articles are also described.

### TECHNICAL FIELD

The subject matter described herein relates to a business intelligence computing system that supports relational data arranged in hierarchies.

### BACKGROUND

Business intelligence computing systems (BI) include software and computing hardware that enable the transformation of raw data from a variety of data sources into meaningful and useful information for business analysis purposes. BI computing systems have been widely adopted because they are capable of handling large amounts of unstructured data to help identify, develop and otherwise interpret rich and complex data. Conventional BI applications have limited abilities to support hierarchical workflows using simple and flat relational data sources.

### SUMMARY

In one aspect, a business intelligence (BI) computing system obtains a plurality of relational data records from a data source that has an associated hierarchy description. The BI computing system, using the hierarchy description, next builds a hierarchical structure of the plurality of data records. Subsequently, the BI computing system, using the hierarchical structure, initiates at least one hierarchical workflow operation to allow a user to display, analyze, and navigate the plurality of data records on a BI client.

The hierarchical structure can be built by iterating through the plurality of data records to form a plurality of nodes. The building can include determining, for each field in each record, whether a hierarchy is active on the related dimension. Levels of the hierarchical structure can be recursively run through to retrieve parent nodes for those fields in which there is a hierarchy active on the related dimension. A sparse matrix can be generated in which the nodes of the hierarchy can be stored. Tuple elements can be generated for each of the nodes.

The hierarchical arrangement of the plurality of data records can be a leveled hierarchy and/or a parent-child hierarchy and/or a modeled hierarchy.

Non-transitory computer program products (i.e., physically embodied computer program products) are also described that store instructions, which when executed by one or more data processors of one or more computing systems, causes at least one data processor to perform operations herein. Similarly, computer systems are also described that may include one or more data processors and memory coupled to the one or more data processors. The memory may temporarily or permanently store instructions that cause at least one processor to perform one or more of the operations described herein. In addition, methods can be implemented by one or more data processors either within a single computing system or distributed among two or more computing systems. Such computing systems can be connected and can exchange data and/or commands or other instructions or the like via one or more connections, including but not limited to a connection over a network (e.g. the Internet, a wireless wide area network, a local area network, a wide area network, a wired network, or the like), via a direct connection between one or more of the multiple computing systems, etc.

The subject matter described herein provides many technical advantages. For example, unlike conventional BI clients that do not support hierarchical workflows on the top of relation data, the current subject matter allows such workflows which, in turn, enables complex modelling for a variety of data sources.

The details of one or more variations of the subject matter described herein are set forth in the accompanying drawings and the description below. Other features and advantages of the subject matter described herein will be apparent from the description and drawings, and from the claims.

### DESCRIPTION OF DRAWINGS

FIG. 1 is a diagram illustrating a business intelligence consumer services computing system architecture;

FIG. 2 is a diagram illustrating a relational mapper that maps relational data to multidimensional data;

FIG. 3 is a diagram illustrating building of a hierarchy structure;

FIG. 4 is a process flow diagram illustrating building of a hierarchy structure;

FIG. 5 is a diagram illustrating a sparse matrix for hierarchical records;

FIG. 6 is a diagram illustrating a sparse matrix for hierarchical records with multiple hierarchies;

FIG. 7 is a diagram illustrating a sample hierarchical result set;

FIG. 8 is a process flow diagram illustrating the creation of tuple elements;

FIG. 9 is a diagram illustrating tuples with multiple dimensions;

FIG. 10 is a diagram illustrating aggregation for new tuples;

FIG. 11 is a diagram illustrating analysis of drill context; and

FIG. 12 is a process flow diagram illustrating the support of hierarchies in a relational data system.

Like reference symbols in the various drawings indicate like elements.

### DETAILED DESCRIPTION

The current subject matter provides a way to use hierarchies in business intelligence (BI) tools on top of simple and flat relational data sources such as CSV-files. Hierarchies, as used herein, refers to hierarchy workflows supported in most BI tools such as hierarchical value help and filtering, hierarchical result sets and hierarchical navigations within this result set (as will be described in more detail below). In particular, the current subject matter describes how to define such hierarchies, how to build the hierarchical structure, compute the values and perform interactions (filtering and navigations) on top of these hierarchies.

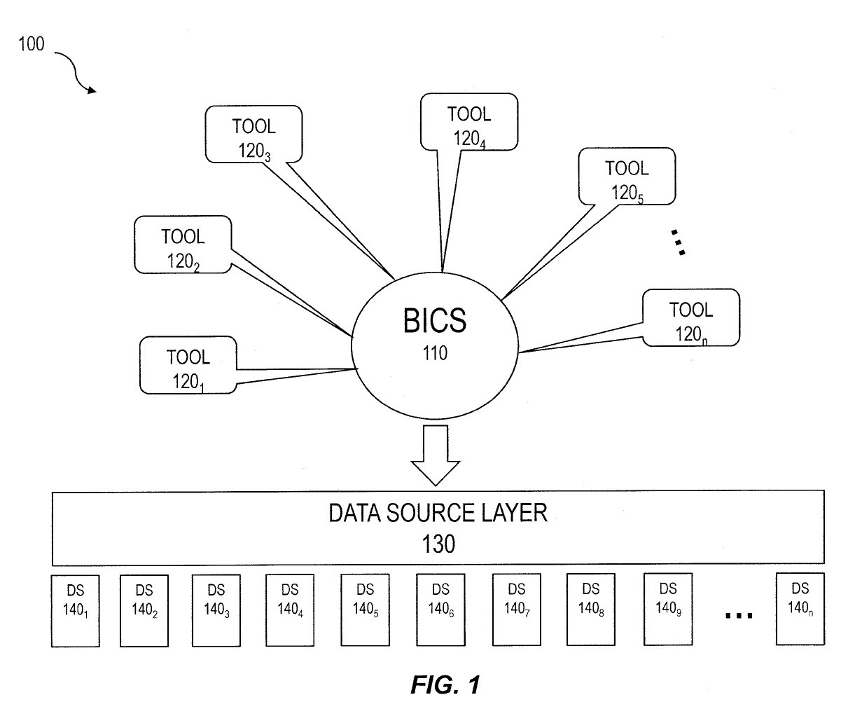

FIG. 1 is a diagram 100 illustrating a sample business intelligence architecture that includes a data access layer 110 (also referred to herein as business intelligence consumer services or BICS) that interfaces with a plurality of tools 120_{1 . . . n}, which in turn, can access a plurality of data sources 140_{1 . . . n} via at least one data source layer 130. These tools 120_{1 . . . n} can include, for example, business intelligence (BI) frontend tools, planning applications and JAVA applications running in a portal to work with selections and access data, such as OLAP data, in a unified way for different data sources 140_{1 . . . n}. These different data sources 140_{1 . . . n} can store data (which can also have differing formats) in a variety of ways including data that is stored in an SAP BUSINESS WAREHOUSE platform and SAP HANA platform as well as other types of data sources. As mentioned above, the data stored in the data sources 140_{1 . . . n} can be of different formats including relational data such as CSV files.

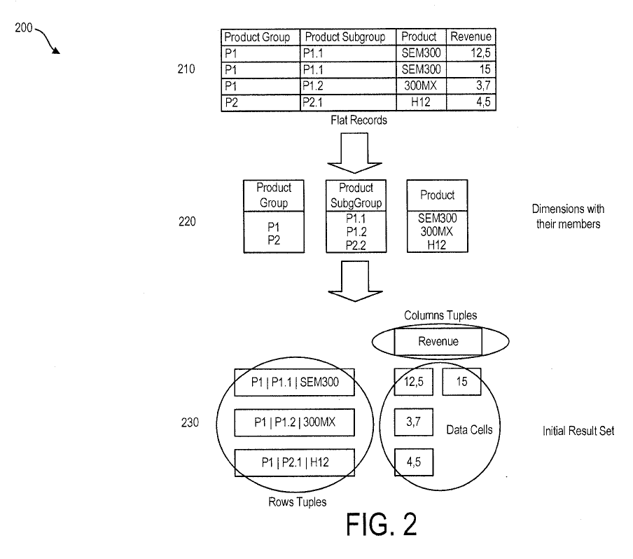

FIG. 2 is a diagram 200 that illustrates a relational mapper, forming part of the data access layer 110 that maps relational data to multidimensional data. From the relational data 210 (e.g. a CSV-file, etc.) dimensions with their unique members can be created 220. Based on these members the result tuple elements can then be created followed by the tuples and the corresponding data cells 230. When multiple records for one tuple are available the data cells need to be aggregated.

One or more of the data sources 140_{1 . . . n} can include a hierarchy description. As an example, a relational data source, based on a CSV-file consumed by a provider, can be based on a CSV-file containing the actual data and a section or separate CSV-file containing the metadata description. Within this metadata section, the hierarchy description can be located.

The hierarchy description can specify a hierarchy type, a name and possibly a description for the hierarchy and/or an actual description of the hierarchy structure. First, the hierarchy can have a dimension it is based on (i.e., the reference characteristic, etc.) which describes the dimension to which this hierarchy can be assigned and which holds the leaves of this hierarchy.

The current subject matter can handle various types of hierarchies. Level hierarchies, are one example illustrated in Table 1 below, that can have a structure build that is based on one or more levels (e.g., a retailer hierarchy with the countries they are located in as the top level and the cities within these countries as the second level as illustrated, etc.).

TABLE 1

| <<BEGIN OF HIERARCHIES>> | | | | | |
|---|---|---|---|---|---|
| | | Reference | Level | | |
| Type | Name | Characteristic | Count | | |
| LEVEL | RetailerLocation | retailer | 2 | country | city |

<<END OF HIERARCHIES>>

In addition as this is a level hierarchy, the structure can be defined by a set of levels. In this example the dimension “retailer” is hierarchical with the location on the first level and the city on the second level.

Another example of a hierarchy type are parent-child hierarchies that can comprise a build on the mappings between one or more pairs of two columns where one forms the parent and one the child.

TABLE 2

| <<BEGIN OF HIERARCHIES>> | | | | |
|---|---|---|---|---|
| | | Reference | | |
| Type | Name | Characteristic | Parent | Child |
| ParentChild | Managers | employee | manager | Employee |

<<END OF HIERARCHIES>>

Modeled hierarchies are another type that can require a more complex definition as here the complete hierarchy structure needs to be modeled. On the other hand, modeled hierarchies are much more flexible.

A definition for a modeled hierarchy can contain the complete hierarchy starting by the root nodes up to the leaves:
Root1
   Node1
      Leaf1
   Node2
      Leaf2
      Leaf3
   Leaf4
Leaf5

This definition can be read while parsing the metadata and the objects representing these hierarchies and their metadata can be created and attached to the reference characteristic (i.e., the dimension to which the hierarchy belongs, etc.).

To use the hierarchy in an analytical tool (e.g. SAP DESIGN STUDIO, etc.), one or more of the following features can be made available in the data access layer 110: (i) hierarchical value help, (ii) hierarchical filter support, (iii) hierarchical display in the result set, (iv) navigation within the hierarchy (drilling), and (iv) aggregate leaves to get a node amount.

With the value help feature, the hierarchy description can be parsed to form metadata of the hierarchies. When the hierarchy is consumed, the data records can be read to build up the hierarchical structure. To do this the records can be iterated. The constraints can be:
Each field in a record that relates to a dimension with an assigned hierarchy represents a leaf in the hierarchy.
Each leaf has 0 . . . 1 parent nodes (depending on the hierarchy type).
   If no parent node, the leaf will be added to the top level of the hierarchy.
Each parent node again has 0 . . . 1 parent nodes.
   If no parent node, the node will be added to the top level of the hierarchy.

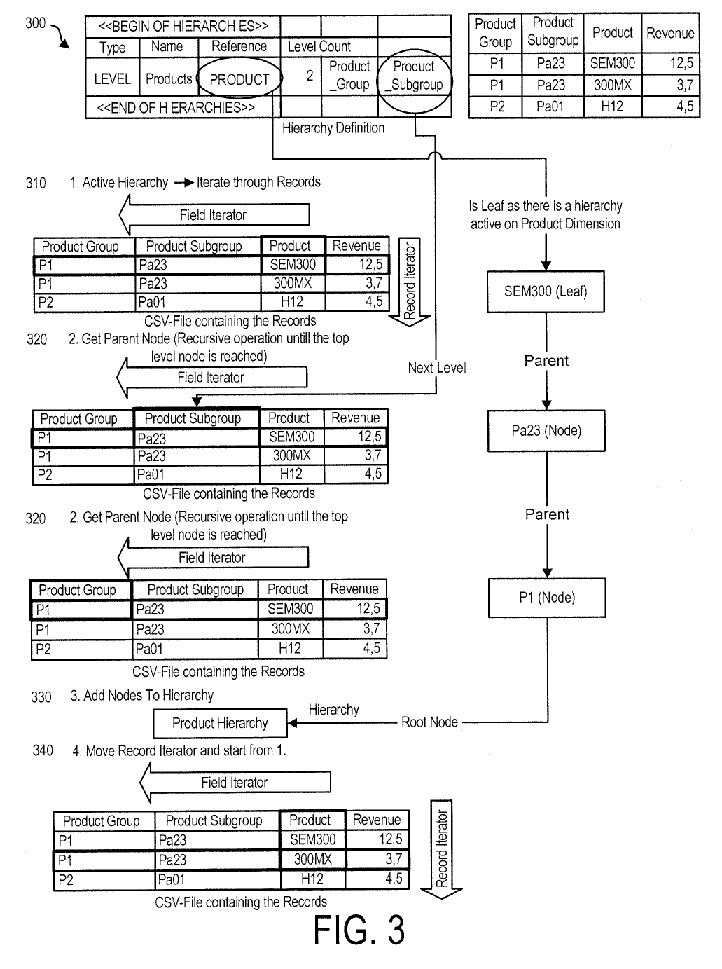

With reference to diagrams 300 of FIG. 3, therefore when a hierarchy is activated, the records can be run through and each field can be checked to determine whether a hierarchy is active on the related dimension. If that is the case, the levels of the hierarchy can be recursively run through to retrieve the parent nodes. In particular, at 310, the hierarchy is activated such that all of the records are iterated through. Thereafter, at 320, the parent node is obtained by performing a recursive operation until the top level node is reached. Nodes are then added, at 330, to the hierarchy. Once all nodes are added, then the iterative process, at 340, moves to the next record.

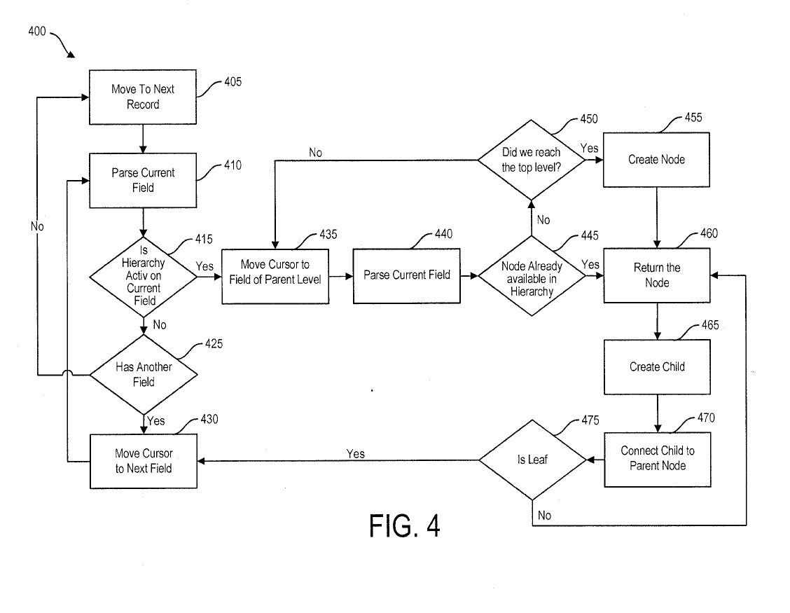

With reference now to diagram 400 of FIG. 4, if the recursion advances from a first record (405) to a field (410) that has a hierarchy that is known to be the current value is a leaf of the hierarchy, the process checks what is the next level of this hierarchy (in the example “Product Subgroup”) (415-430). The cursor is then moved to the field related to the next level (435) and this value is parsed (440). Thereafter, it can be checked whether a node with this key is already available in the hierarchy (445). If not, then the cursor moves to the next higher level (here “Product Group”) until an already existing node is reached or the top level of the hierarchy is reached (450). Then all nodes are created (455-470) from top to bottom and connected and finally the leaf is created (475). Then, the cursor can move to the next records line (405). As a result in the end, a hierarchical tree is available starting from the root nodes down to all leaves. This hierarchical tree can be used to display a hierarchical value help.

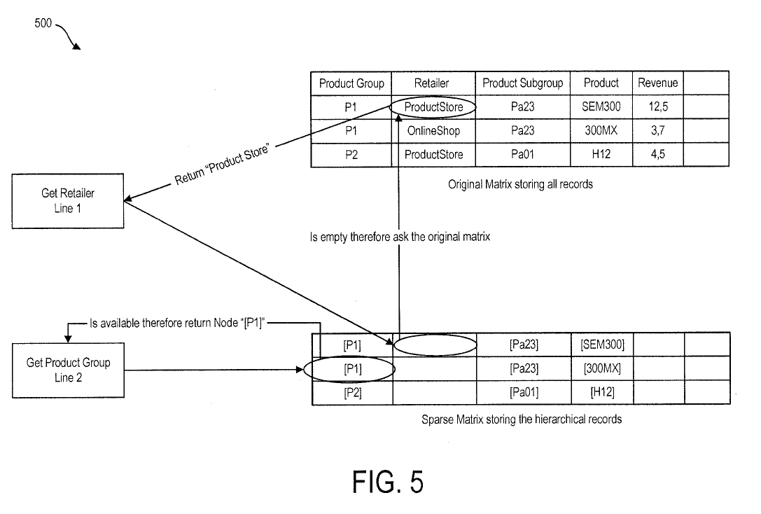

To save memory these newly adjusted/created objects can be stored in a sparse matrix (such as that illustrated in diagram 500 of FIG. 5) that overrules an original records matrix. If this hierarchical records matrix contains an entry, it wins otherwise the normal (flat) record from the original matrix is returned.

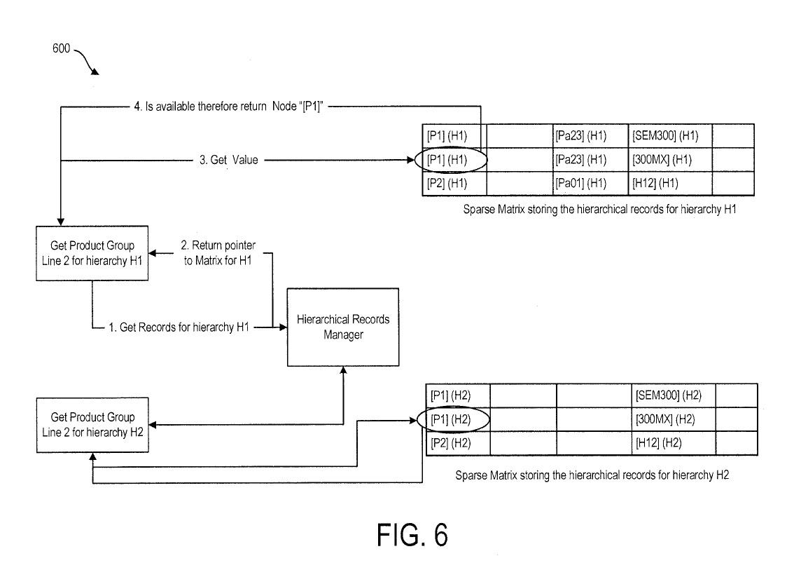

In case there are multiple hierarchies active at the same point in time on multiple dimensions, multiple sparse matrices can be used to store the hierarchical records. FIG. 6 is a diagram 600 of a sparse matrix for hierarchical records with multiple hierarchies.

This sparse matrix can be useful as the same position in the records might be needed for multiple different nodes. For example, Product Group [P1] might be a leaf in one hierarchy but at the same time a node in another hierarchy. Therefore a manager can be used that holds references to the different record matrices (one per active hierarchy). When accessing a hierarchical record this manager, can return a pointer to the correct hierarchical records matrix for the given hierarchy. Again if an entry is missing for any of these hierarchies the original matrix can be accessed.

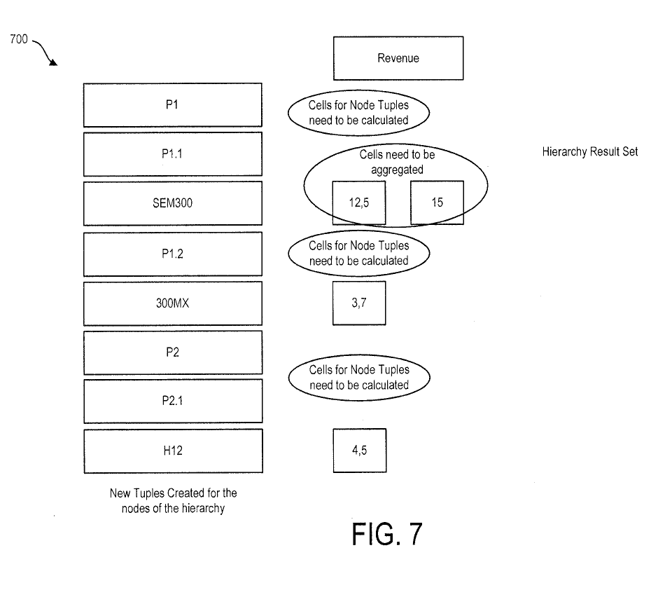

With conventional workflows, for each unique record a tuple and data cells can be created. In case the record returns a hierarchical object (node or leaf) a different workflow is required because additional tuples for the nodes need to be created. Therefore, an initial result set with the newly created tuples can look like that of diagram 700 of FIG. 7.

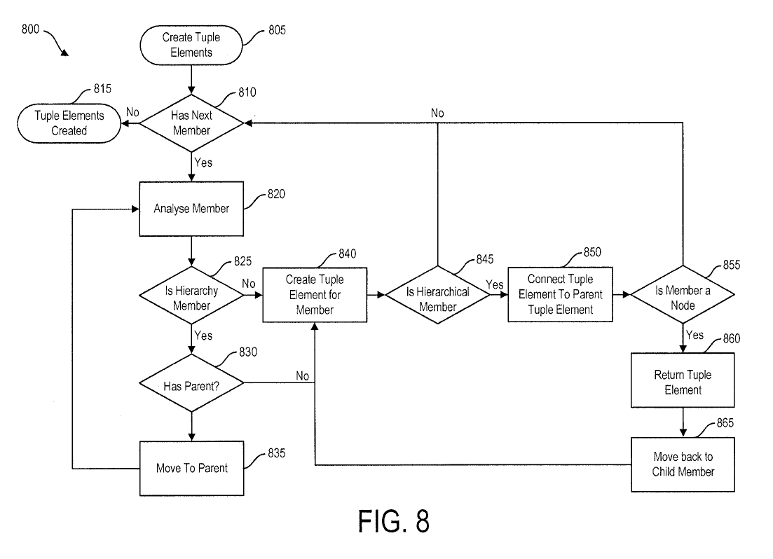

To identify needed tuples and to build them the following a process such as that in diagram 800 of FIG. 8 can be used. If a hierarchical member (leaf or node) is reached, a recursive function can be used to iterate through the parent elements of this member to create tuples for all parent nodes respectfully finding the already existing (i.e. already created) parent tuple (for one dimension on the axis tuple elements are basically identical to the tuples). As a result all required tuple elements can be created and the corresponding tuples are created afterwards.

In particular, it can initially be determined that a new tuple element is to be created (805). It is then determined if there is a next member of the hierarchy (810) and if it not, then the new tuple element is created (815). If there is a next member, then such member is analyzed (820) to determine if it is a hierarchy element (825). If so, then it is determined whether it has a parent (830), and if so, then the process moves to the parent (835). If no hierarchy member exists or there is no parent, then a tuple element is created for the member (840). It is then determined whether the member having the newly created tuple element is a hierarchy member (845). If not, then the process reverts back to checking the next member (810). Otherwise, the tuple element is connected to the parent tuple element (850). Is then determined whether this member is a node (855). If not, then process reverts back to checking the next member (810). If so, then the tuple element is returned (860) and the process moves back to the child member (865). The process then continues to create tuple element for the member (840).

In case multiple dimensions are put on one axis or multiple hierarchies are active on one axis, the workflow gets more complex as now the single tuple elements need to be connected with each other. And the newly created artificial hierarchy tuples need to be available on all levels.

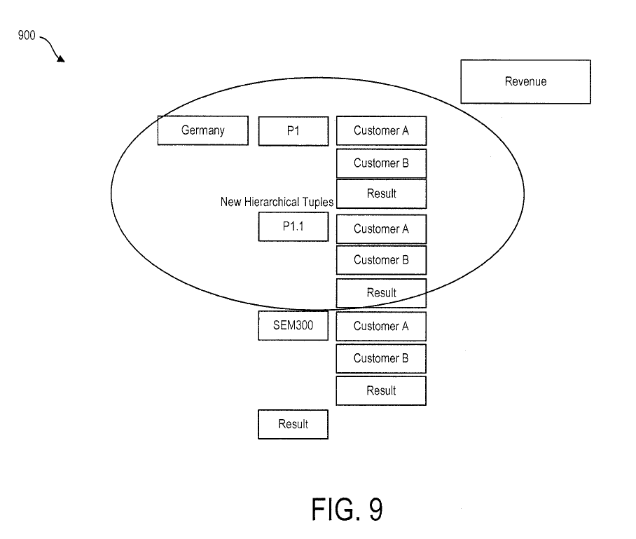

Diagram 900 of FIG. 9 shows the tuples for a result set with three dimensions on the rows axis with the hierarchy in the middle of them. For each node or leaf in the hierarchy all elements of the next inner dimension need to be repeated and of course the data needs to be aggregated accordingly.

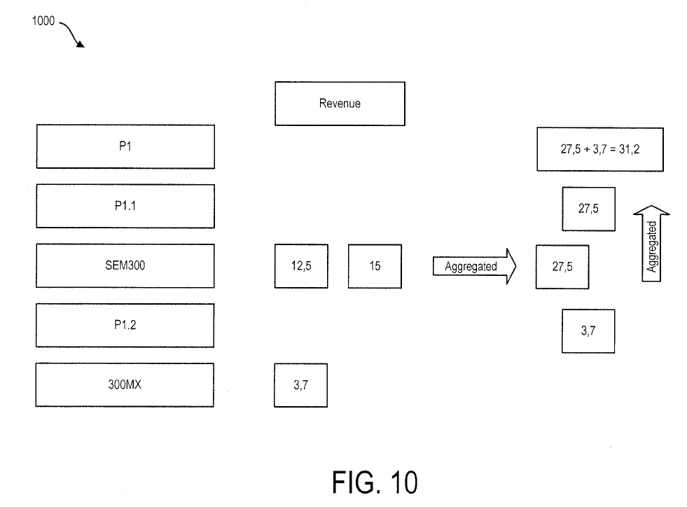

For the newly created tuples (for the nodes) data cell values need to be calculated by aggregating their children. To do this all single values can be collected and then run through an aggregation logic that calculates the value depending on the aggregation type. For reference, see diagram 1000 of FIG. 10 which illustrates an aggregation for new tuples.

Initially, the single values can be calculated by aggregating all values of identical records (in the below example there were two records for “SEM300” so both values need to be aggregated). Subsequently, a new logic can be used to calculate the values for the new hierarchy tuples. To do this all single values of the leaves positioned under the node of the current tuple are collected and aggregated.

A filter can iterate through all available tuples (e.g., a cube) and checks for each tuple if it is inside the filter criteria or outside.

For hierarchical filters a comparison is not enough anymore as a filter on a node means filtering all its children as well. Therefore, for each hierarchical filter all tuples can be checked to determine if the member or any of its parents is contained in the filter.

So for the following hierarchy with a filter on “Node2”:
Root1
   Node1
      Leaf1
   Node2
      Leaf2
      Leaf3

A check can be run through with all six tuples, the first three would return false, the following three true as they are either equal to the filter or children of the filtered node.

With hierarchy navigations, a drill down can return the delta tuples that are requested. For the following example if “Node2” is collapsed and should be drilled down (i.e. expanded), a delta of two tuples can be returned (“Leaf2” and “Leaf3”).
Root1
   Node1
      Leaf1
   Node2
      Leaf2
      Leaf3

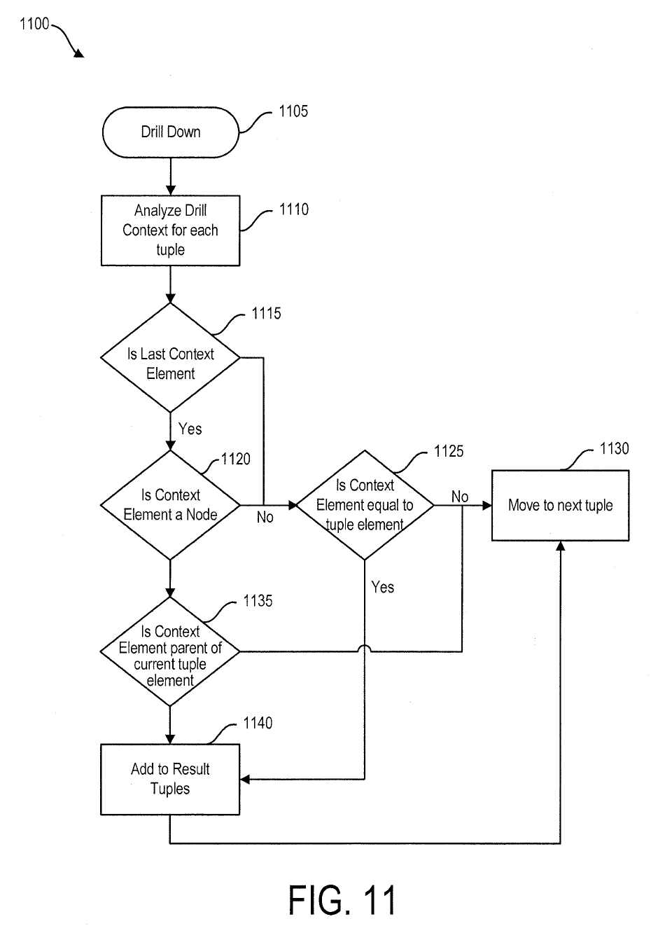

To accomplish the above, the description of where to drill is handed over, and then filtering can performed in a manner similar to that above. All tuples can be checked to determine if they match the drill context. The drill context can contain a path of tuple elements that describes where the drill down happens. So for each tuple, the drill context elements (i.e., tuple elements) can be iterated over and the check illustrated in diagram 1100 of FIG. 11 can be done to check whether the tuple should be returned or not. In particular, as part of a drill down operation (1105), the drill context is analyzed for each tuple (1110). Next, it is determined whether the element is the last content element (1115). If so, then it is determined whether the content element is a node of the hierarchical structure (1120). If not, it is then determined if the content element is equal to the tuple element (1125). If so, then the content element is added to the tuple (1140) and, if not, then the process moves to the next tuple (1130). Going back to the determination of whether the content is an element (1120), if the answer is yes, it is then determined whether the content element is a parent of a current tuple element (1135). If so, then the content element is added to the tuple (1140)—otherwise the process reverts to a determination of whether the content element is equal to the tuple element (1125).

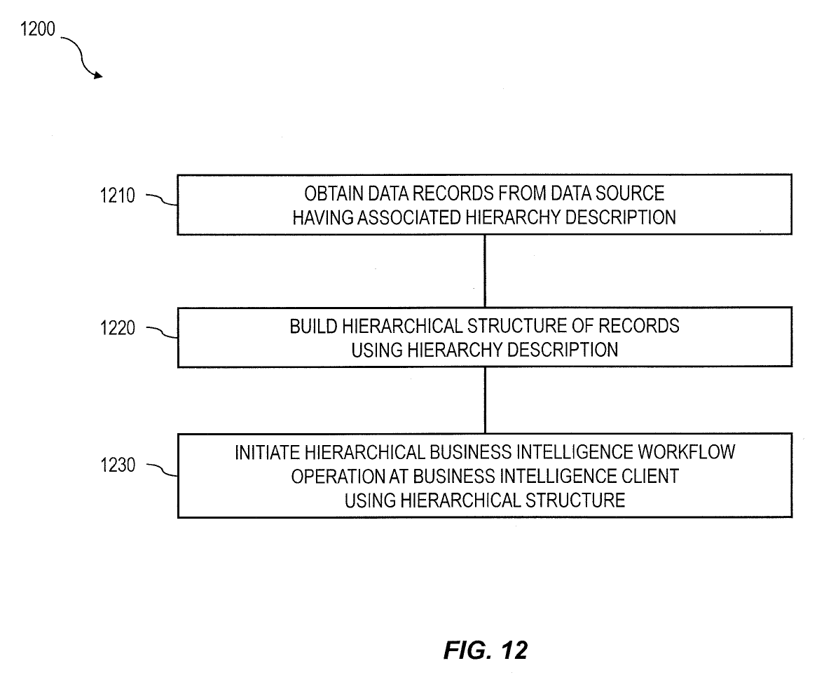

FIG. 12 is a process flow diagram 1200 in which, at 1210, a plurality of relational data records are obtained from a data source that has an associated hierarchy description. Subsequently, at 1220, the BI computing system builds a hierarchical structure of the plurality of data record using the hierarchy description. Later, at 1230, the BI computing system using the hierarchal structure initiates at least one hierarchical workflow operation to allow a user to display, analyze, and navigate the plurality of data records on a BI client.

One or more aspects or features of the subject matter described herein can be realized in digital electronic circuitry, integrated circuitry, specially designed application specific integrated circuits (ASICs), field programmable gate arrays (FPGAs) computer hardware, firmware, software, and/or combinations thereof. These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable system or computing system may include clients and servers. A client and server are generally remote from each other and typically interact through a communication network. The relationship of client and server arises by virtue of computer programs running on the respective computers and having a client-server relationship to each other.

These computer programs, which can also be referred to as programs, software, software applications, applications, components, or code, include machine instructions for a programmable processor, and can be implemented in a high-level procedural language, an object-oriented programming language, a functional programming language, a logical programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid-state memory or a magnetic hard drive or any equivalent storage medium. The machine-readable medium can alternatively or additionally store such machine instructions in a transient manner, such as for example as would a processor cache or other random access memory associated with one or more physical processor cores.

To provide for interaction with a user, one or more aspects or features of the subject matter described herein can be implemented on a computer having a display device, such as for example a cathode ray tube (CRT) or a liquid crystal display (LCD) or a light emitting diode (LED) monitor for displaying information to the user and a keyboard and a pointing device, such as for example a mouse or a trackball, by which the user may provide input to the computer. Other kinds of devices can be used to provide for interaction with a user as well. For example, feedback provided to the user can be any form of sensory feedback, such as for example visual feedback, auditory feedback, or tactile feedback; and input from the user may be received in any form, including, but not limited to, acoustic, speech, or tactile input. Other possible input devices include, but are not limited to, touch screens or other touch-sensitive devices such as single or multi-point resistive or capacitive trackpads, voice recognition hardware and software, optical scanners, optical pointers, digital image capture devices and associated interpretation software, and the like.

In the descriptions above and in the claims, phrases such as “at least one of” or “one or more of” may occur followed by a conjunctive list of elements or features. The term “and/or” may also occur in a list of two or more elements or features. Unless otherwise implicitly or explicitly contradicted by the context in which it is used, such a phrase is intended to mean any of the listed elements or features individually or any of the recited elements or features in combination with any of the other recited elements or features. For example, the phrases “at least one of A and B;” “one or more of A and B;” and “A and/or B” are each intended to mean “A alone, B alone, or A and B together.” A similar interpretation is also intended for lists including three or more items. For example, the phrases “at least one of A, B, and C;” “one or more of A, B, and C;” and “A, B, and/or C” are each intended to mean “A alone, B alone, C alone, A and B together, A and C together, B and C together, or A and B and C together.” In addition, use of the term “based on,” above and in the claims is intended to mean, “based at least in part on,” such that an unrecited feature or element is also permissible.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and subcombinations of the disclosed features and/or combinations and subcombinations of several further features disclosed above. In addition, the logic flows depicted in the accompanying figures and/or described herein do not necessarily require the particular order shown, or sequential order, to achieve desirable results. Other implementations may be within the scope of the following claims.

What is claimed is:

1. A method comprising:
obtaining, by a business intelligence (BI) computing system, a plurality of relational data records from a data source, the data source having an associated hierarchy description;
building, by the BI computing system using the hierarchy description, a hierarchical structure of the plurality of data records; and
initiating, by the BI computing system using the hierarchical structure, at least one hierarchical workflow operation to allow a user to display, analyze, and navigate the plurality of data records on a BI client.

2. The method of claim 1, wherein the hierarchical structure is built by iterating through the plurality of data records to form a plurality of nodes.

3. The method of claim 2, wherein the building comprises: determining, for each field in each record, whether a hierarchy is active on the related dimension.

4. The method of claim 3 further comprising:
recursively running through levels of the hierarchical structure to retrieve parent nodes for those fields in which there is a hierarchy active on the related dimension.

5. The method of claim 4 further comprising:
generating a sparse matrix and storing the nodes in the sparse matrix.

6. The method of claim 2 further comprising:
generating tuple elements for each of the nodes.

7. The method of claim 1, wherein the hierarchical arrangement of the plurality of data records comprises a leveled hierarchy.

8. The method of claim 1, wherein the hierarchical arrangement of the plurality of data records comprises a parent-child hierarchy.

9. The method of claim 1, wherein the hierarchical arrangement of the plurality of data records comprises a modeled hierarchy.

10. A system comprising:
at least one data processor; and
memory storing instructions which, when executed by the at least one data processor, result in operations comprising:
obtaining, by a business intelligence (BI) computing system, a plurality of relational data records from a data source, the data source having an associated hierarchy description;
building, by the BI computing system using the hierarchy description, a hierarchical structure of the plurality of data records; and
initiating, by the BI computing system using the hierarchical structure, at least one hierarchical workflow operation to allow a user to display, analyze, and navigate the plurality of data records on a BI client.

11. The system of claim 10, wherein the hierarchical structure is built by iterating through the plurality of data records to form a plurality of nodes.

12. The system of claim 11, wherein the building comprises: determining, for each field in each record, whether a hierarchy is active on the related dimension.

13. The system of claim 12, wherein the operations further comprise:
recursively running through levels of the hierarchical structure to retrieve parent nodes for those fields in which there is a hierarchy active on the related dimension.

14. The system of claim 13, wherein the operations further comprise:
generating a sparse matrix and storing the nodes in the sparse matrix.

15. The system of claim 11, wherein the operations further comprise:
generating tuple elements for each of the nodes.

16. The system of claim 10, wherein the hierarchical arrangement of the plurality of data records comprises a leveled hierarchy.

17. The system of claim 10, wherein the hierarchical arrangement of the plurality of data records comprises a parent-child hierarchy.

18. The system of claim 10, wherein the hierarchical arrangement of the plurality of data records comprises a modeled hierarchy.

19. A non-transitory computer program product storing instructions which, when executed by at least one data processor forming part of at least one computing device, result in operations comprising:
obtaining, by a business intelligence (BI) computing system, a plurality of relational data records from a data source, the data source having an associated hierarchy description;
building, by the BI computing system using the hierarchy description, a hierarchical structure of the plurality of data records; and
initiating, by the BI computing system using the hierarchical structure, at least one hierarchical workflow operation to allow a user to display, analyze, and navigate the plurality of data records on a BI client.

20. The computer program product of claim 19, wherein:
the hierarchical structure is built by iterating through the plurality of data records to form a plurality of nodes;
the building comprises determining, for each field in each record, whether a hierarchy is active on the related dimension;
the operations further comprise recursively running through levels of the hierarchical structure to retrieve parent nodes for those fields in which there is a hierarchy active on the related dimension.
